(19) United States
(12) Patent Application Publication
(10) Pub. No.: US 2019/0225901 A1
(43) Pub. Date: Jul. 25, 2019

(54) Industrial Fluid

(71) Applicant: CASTROL LIMITED, Reading, Berkshire (GB)

(72) Inventors: Andre HENDRIKSEN, Moenchengladbach (DE); Robert Paul HUDSON, Reading, Berkshire (GB); Hendrik PESCHEL, Moenchengladbach (DE)

(21) Appl. No.: 16/316,340

(22) PCT Filed: Jul. 7, 2017
(86) PCT No.: PCT/EP2017/067142

§ 371 Date: Jan. 8, 2019

(30) Foreign Application Priority Data
Jul. 8, 2016 (EP) 16178753.6

(51) Int. Cl. C10L 1/32; C10L 1/198; C10L 10/04; C10M 173/00; C09K 8/06; C09K 8/36

(52) U.S. Cl. CPC C10L 1/328; C10N 2230/18; C10L 10/04; C10M 173/00; C09K 8/06; C09K 8/36; C10L 2250/06; C10L 2290/24; C10M 2203/003; C10M 2201/02; C10N 2240/401; C10N 2240/402; C10N 2240/10; C10N 2240/08; C10N 2250/021; C10N 2250/022; C09K 2208/34; C10L 1/1985

(57) ABSTRACT

An industrial fluid is disclosed. The fluid comprises an oleaginous component, an aqueous component, and a surfactant dispersed in the aqueous component. The industrial fluid does not contain defoamers or anti-foam compounds. The surfactant is bound within micelles of the oleaginous component and the aqueous component.

### INDUSTRIAL FLUID

The present invention relates to an industrial fluid, in particular an industrial fluid comprising an oleaginous component, an aqueous component and a.

Industrial fluids find many applications within industry, such as lubricating fluids, coolants and fuels. For example, these range from powering vehicles, cooling drilling apparatus, lubricating car engines and gear boxes, to subsea machinery, wind turbines, power generators and materials processing (cutting, grinding, rolling) to name but a few. Each of these industrial fluids has in common a basic composition of an oleaginous component, an aqueous component and a surfactant dispersed in the aqueous component to form an emulsion. Such oleaginous components are typically derived from hydrocarbon sources by, for example, the refining of crude oil or shale oil, or esterification.

Including aqueous components into an oleaginous base or vice versa involves the use of emulsifiers to create an emulsion, since such aqueous and oleaginous materials are naturally immiscible. Examples of industrial fluids comprising aqueous emulsions include metalworking fluids and other water-based fluids. Surfactants are typically used to emulsify the aqueous and oleaginous components, with sufficient surfactant included to ensure that the emulsion forms completely. Ideally there should be no residual immiscible components, and the emulsion should be stable, such that the individual components do not separate out during storage or use. Using too much surfactant however can result in foaming of the emulsified mixture, either immediately on mixing or during use. To reduce the likelihood of this occurring defoamers or antifoam compounds are also included in the industrial fluid to prevent formation of or reduce the amount of foam due to surfactants. This combination results in stable emulsions with reduced tendency to foam.

It would be advantageous however to be able to produce industrial fluids as complete, stable emulsions, without the use of defoamers or a surplus of surfactants.

The present invention aims to address this need by providing, in a first aspect, an industrial fluid comprising: an oleaginous component; an aqueous component; and a surfactant; wherein the oleaginous component and the aqueous component form micelles with the surfactant, wherein the industrial fluid does not contain defoamers or anti-foam compounds, and wherein in use, the industrial fluid is substantially free from foam.

In a second aspect, the present invention provides a method of forming an industrial fluid, comprising: forming a first fluid comprising an aqueous solution of a surfactant; forming a second fluid comprising an oleaginous compound; mixing the first fluid and the second fluid under a shear force to produce an intermediate fluid; and mixing a third fluid and the intermediate fluid under laminar flow to create an industrial fluid.

In a third aspect, the present invention provides for an industrial fluid made using this process.

The present invention will now be described by way of example only, with reference to illustrative embodiments. Embodiments of the invention take the approach that an industrial fluid may comprise oleaginous components and aqueous components. Oleaginous components, such as mineral oils and base oil stocks, may be emulsified with aqueous components, such as water, as long as there is a surfactant dispersed in the aqueous component. Such aqueous emulsions are used in various applications including lubrication and metalworking. These emulsions may be a fully formulated fluid, that is, one that needs no dilution or mixing before use and represents the full formulation of an industrial fluid, such as a lubricant. Alternatively the emulsions may be used undiluted or diluted using a diluent such as water. Alternatively, the emulsions may be used as an additive to impart various properties when mixed with a carrier fluid. The carrier fluid may be chosen from lubricating, energy dissipating or energy generating fluids, such that the industrial fluid becomes an additive to these, with these fluids themselves comprising emulsions. The industrial fluid is substantially free of insoluble defoamers or anti-foam compounds to compensate for foaming caused by excess surfactant. By forming a micelle structure that is precisely controlled, the surfactant is bound up in the micelle structure, and there is substantially no unbound surfactant is present within the industrial fluid. This is also the case when the industrial fluid is used as an additive to an emulsion of other carrier fluid. In addition, the industrial fluid does not add to any foaming behaviour, and/or may have a tendency to reduce any foaming of the carrier fluid.

A micelle is an aggregate of surfactant molecules dispersed in a colloid, where particles of a first material are suspended in a second material, creating a two-phase system. Unlike in a solution, the first material is insoluble or immiscible in the second material so becomes an emulsion. In an aqueous solution a micelle forms an aggregate with the hydrophobic tails of the surfactant molecules facing inwards and the hydrophilic heads of the surfactant molecules facing outwards. This forms a normal-phase micelle, leading to an oil-in-water phase mixture. An inverse-phase micelle has the inverse structure, where the hydrophilic heads of the surfactant molecules face inwards and the hydrophobic tails face outwards. This leads to a water-in-oil phase mixture. The packing behaviour of the surfactant molecules leads to a single layer of surfactant molecules around the core of the micelle, which, following surface energy considerations, typically forms a sphere.

Further layers of surfactant may also be packed around the outside of the micelle. This will be the case when further surfactant is added to the mixture. For example, when shear forces are applied to an oleaginous component this causes the oleaginous component to stretch. This stretching causes the molecules to flatten out and tend towards a laminar structure, this increasing the surface area any surfactant has available to be attracted to. Coupled with a laminar flow around the molecule of a dispersion of surfactant in water, the packing fraction of the surfactant increases from ≤⅓ to >½. Once the shear force is removed from the molecule it forms a spherical micelle due to surface energy considerations, unless, of course, the structure of the surfactant causes the minimum surface energy configuration of a micelle to be laminar or cylindrical. For example, Gemini surfactants, sometimes known as dimeric surfactants, have two hydrophobic tails that distort the core of the micelle into an elongated ovoid shape.

At this point the surfactant packing fraction reduces back to ≤⅓ for spherical micelles, so any additional surfactant attracted to the temporary laminar configuration of the molecule forms additional layers of surfactant around the micelle. However, only odd numbers of layers form, since for a normal-phase micelle the even layers of surfactant molecules are arranged with the hydrophilic heads in contact with the hydrophilic heads of the first layer of surfactant molecules, and the hydrophobic tails pointing outwards. The inverse is true for an inverse-phase micelle. Therefore in both cases a micelle will have 1, 3, 5, 7 . . . n=2k+1 layers of surfactant. This also results in there being effectively no free surfactant in any form within the emulsion, as surfactant will be bound within these micelles, in multiple layers. Consequently, there is substantially no unbound surfactant present in the fluid. The more surfactant added into the emulsion the greater the number of layers of surfactant. For example, the fluid may be used as a fully formulated fluid or as an additive fluid, depending upon then final purpose of the liquid. The surfactant may comprise at least one ionic surfactant, at least one non-ionic surfactant or a mixture thereof. Preferably, the surfactant is a non-ionic surfactant, since using an ionic surfactant may have an effect on the corrosion inhibition behaviour of the industrial fluid. However, there are situations where an ionic surfactant may be beneficial. Therefore whilst the main surfactant component within the surfactant layers may be a non-ionic surfactant other ionic surfactants may be present within the layer, since this offers various advantages in terms of tailoring the surfactant performance. The industrial fluid embodiments in accordance with the present invention may be used undiluted, dilute or as an additive to a carrier fluid. When used undiluted, the industrial fluid can be taken directly from the manufacturing process and used as a neat emulsion. Alternatively, it may be desirable to dilute the industrial fluid using a quantity of water, thereby decreasing the viscosity of the emulsion. Water is used as a diluent in industrial fluids used in lubrication and metalworking applications. An additive fluid is one that is added into a carrier fluid, such as another emulsion with lubricating properties. In this situation the carrier fluid will have a certain viscosity and may also contain anti-foam or defoamer compounds, which may be soluble or insoluble within the emulsion. For the industrial fluid to work well as an additive it is important that it does not make any foaming behaviour worse than in the original emulsion, otherwise additional anti-foam or defoamer compounds will be required to ensure the performance of the carrier fluid and the industrial fluid mix. In this situation embodiments of the present invention are very useful, since their surfactant content is bound up in the micelles of the oleaginous component in the aqueous component. This dilution step may be carried out more than once, effectively forming a series of fluids with the industrial fluid diluted further and further to create certain performance behaviour. For example, it may be desirable to tale an amount of the industrial fluid and dilute it with water to create a custom lubrication fluid with known surfactant behaviour and viscosity.

In this situation the industrial fluid may be used to improve viscosity and/or reduce foaming behaviour.

Use of the method of the present invention to create an industrial fluid also enables materials with high viscosities to be emulsified into a stable emulsion. Using existing techniques it is difficult to emulsify fluids having a viscosity of greater than approximately 100-150 cSt at 40° C. Using the method of the present invention, it is possible to emulsify fluids having a viscosity of 8,000-12,000 cSt at 40° C. The actual limit is dependent upon the temperature of the various components of the emulsification. For example, it may be necessary to heat up components to around 90° C. in order to emulsify such viscosities.

Tailoring the properties of the surfactant removes the need to add any anti-foam or defoaming compounds to the industrial fluid. Anti-foam and defoaming compounds are those materials whose primary action is to defoam (compensate for any foam created by the industrial fluid), and are available in various forms. A popular class of compounds for use with lubricants or metalworking fluids are those having a silicon component. These compounds also have in common that they are insoluble in the fluid used to either form the industrial fluid or to dilute the industrial fluid—typically being water insoluble. Therefore although they are useful in reducing the foaming of the industrial fluid in use, the components themselves can create solubility issues in a final emulsion. The above description is based upon an oleaginous in aqueous emulsion, but the same considerations apply for the inverse situation of an aqueous in oleaginous emulsion. In either case the oleaginous component may comprise a single component, a group of components or a fully formulated fluid.

The advantage therefore of the efficient packing of the surfactant on the micelle surface, regardless of the number of molecular layers of surfactant, is that an industrial fluid having substantially all of the surfactant in the fluid bound up in the micelle structures can be achieved. The use of the micelle structure in industrial fluids and some benefits thereof are described in more detail below.

Industrial fluids typically comprise an oleaginous component, that is, a material that is oily, oil-based or oil-containing in nature. Taking the example of a lubricating fluid, these oleaginous components may be referred to as lubricating compositions. Lubricating compositions may be a fully formulated lubricant or a blend of components, at least one of which has lubricating properties. A fully formulated lubricant is typically based on a lubricating base oil stock. Many different lubricating base oils are known, including synthetic oils, natural oils or a mixture of both, which may be used in both refined or unrefined states (with or without at least one purification step). Natural oils include mineral oils of paraffinic, naphthenic or mixed paraffinic-naphthenic natures, based upon the nature of their source. Synthetic oils include hydrocarbon oils (olefins such as polybutylenes and polypropylenes, for example) and Polyalphaolefins (PAOs). Base oil stock categories have been defined by the American Petroleum Institute (API Publication 1509) providing a set of guidelines for all lubricant base oils. These are shown in Table 1:

TABLE 1
Base Oil Stocks

| | | | Viscosity |
|---|---|---|---|
| | Saturates | Sulphur | Index (VI) |
| Group I | <90 and/or | >0.03% and | ≥80 and <120 |
| Group II | ≥90 and | ≤0.03% and | ≥80 and <120 |
| Group III | ≥90 and | ≤0.03% and | ≥120 |

| | |
|---|---|
| Group IV | Includes Polyalphaolefins (PAO) and |
| | GTL (gas-to-liquid) products |
| Group V | All other base oils not included in Groups I, II, III or IV |

Group II and/or Group III base oils such as hydrocracked and hydroprocessed base oils, as well as synthetic oils such as polyalphaolefins, alkyl aromatics and synthetic esters are wells known base oils. Group III oil base stock tends to be highly paraffinic with saturates higher than 90%, a viscosity index over 125, low aromatic content (less than 3%) and an aniline point of at least 118. Synthetic oils include hydrocarbon oils such as polymerised and interpolymerised olefins, such as polybutylenes, polypropylenes, propylene isobutylene copolymers and ethylene alphaolefin copolymers. PAOs (Polyalphaolefins) are typically derived from C₆, C₈, C₁₀, C₁₂, C₁₄ and C₁₆ olefins or mixtures thereof. Such PAOs typically have a viscosity index greater than 135. PAOs can be manufactured by catalytic oligomerisation (polymerisation to low molecular weight products) of linear α-olefin (otherwise known as LAO) monomers. This leads to the presence of two classes of materials, PAOs and HVI-PAOs (high viscosity index PAOs), with PAOs being formed in the presence of a catalyst such as AlCl₃ or BF₃, and HVI-PAOs being formed using a Friedel-Crafts catalyst or a reduced chromium catalyst.

Esters also form a useful base oil stock, including synthetic esters, as do GTL (gas-to-liquid) materials, particularly those derived from a hydrocarbon source. For example, the esters of dibasic acids with monoalcohols, or the polyol esters of monocarboxyilic acid may be useful. Such esters should typically have a viscosity of less than 10,000 cSt at −35° C., in accordance with ASTM D5293. However, the actual choice of suitable lubricating composition will depend upon the end application for the industrial fluid. For example, some metalworking applications will be based upon mineral oils and/or ester combinations, and some automotive applications will be based upon Group III, IV or V oils. Industrial fluids in accordance with embodiments of the present invention may also be used as additives into synthetic lubricants that carry no emulsified components. This is because the components of a synthetic lubricant product are water soluble, including salts of mixed amine and carboxylic acids and ethylene/propylene oxide block copolymers. Examples of these include Syntilo 9913 and Syntilo 81 BF available from Castrol Limited.

A suitable method of forming a micelle structure for use in industrial fluids is described in US2013/0201785, concerning an apparatus for mixing oleaginous and aqueous materials under a shear force and laminar flow to create either an oil-in-water or a water-in-oil fluid. The basis of the method is as follows: a first fluid comprising an aqueous solution of a surfactant and a second fluid comprising an oleaginous compound are mixed under a shear force to produce an intermediate fluid. This intermediate fluid is in the form of a colloidal emulsion, and has a greater viscosity than either the first or second fluids, and may be free-flowing or gel-like. This intermediate fluid comprises micelles of either the oleaginous fluid in aqueous emulsion or the aqueous fluid in oleaginous emulsion. Both the first and the second fluids are added to a chamber in which stirrers are used to mix the two fluids together under shear force by rotating at a rotational speed of 1200 to 1600 rpm. The shape of the chamber and size of the stirrers are chosen to ensure that a region around the walls of the chamber is devoid of turbulent flow. Thus whilst an oleaginous molecule is under shear an aqueous suspension of a surfactant can flow around the chamber in this region, producing a laminar flow. It is also possible to add a third fluid to the intermediate fluid under laminar flow, for example, increasing the water content of the aqueous fluid to decrease the viscosity of the resulting industrial fluid.

Not wishing to be bound by theory, it is presently understood that as a result of the shear mixing substantially all of the surfactant becomes bound within the micelle structure as described above. That is that substantially all of the surfactant molecules form at least one layer over the surface of the core of the micelle, which may be aqueous or oleaginous as desired. There is substantially no unbound surfactant present in the industrial fluid, where unbound surfactant is characterised as free surfactant molecules within the industrial fluid detectable alone without being part of an oleaginous/aqueous or aqueous/oleaginous micelle. In practice substantially all of the surfactant being bound within the micelle structure results in the fluid being nominally free of excess surfactant. In other words, in use, the fluid is substantially free from foam, and preferably, in use, the fluid does not foam. This also results in the industrial fluid being substantially free of defoamers or anti-foam compounds, since these are no longer required to compensate for any foaming of an oleaginous/aqueous emulsion. The point at which the industrial fluid becomes nominally free of excess surfactant can be determined by measuring the surface tension of the emulsion. Once the critical micelle concentration has been reached, and no more surfactant molecules are included in the surface layer(s), the surface tension of the emulsion exhibits a discontinuity. This may be detected by surface tension measurement techniques known to those skilled in the art. Other techniques for determining this point include NMR (nuclear magnetic resonance) techniques and optical scattering techniques. These include those found in MA Jones-Smith et al, Journal of Colloid and Interface Science 310 (2007) 590-598. Aside from these tests, as well as determining the amount of foam in use of the fluid, a simple agitation test will indicate whether the fluid will foam or not Shaking a container in which the fluid is held should create virtually no foam, such that the fluid is substantially free from foam.

Other additives to improve the performance of the industrial fluid or other components of the industrial fluid may be added at this point. One category of industrial fluid is a lubricating fluid, or which a metalworking fluid is an exemplary form. This is considered in more detail below.

In some embodiments, the present invention provides a method of making an industrial fluid, using the method described above, and an industrial fluid made using that process. The following non-limiting examples are in relation to industrial fluids used in metalworking processes.

Metalworking fluid is a lubricant used in either a destructive metalworking process (one where chips are produced, such as milling) or a deformation metalworking process (one where a material is deformed or shaped such that no chips are produced, for example such as steel rolling). Metalworking fluids are formulated both for the specific type of metal they are used on (such as steel) and for the process they are used in (such as wire drawing). A typical metalworking fluid composition suitable for a destructive process (milling) is characterised by the illustrative composition:

10 to 50 wt % of lubricating composition;

3.0 to 8.0 wt % of surfactant;

5.0 to 10 wt % corrosion inhibitor;

0 to 1.0 wt % yellow metal;

0 to 8.0 wt % esters; and

water to balance.

In this example an industrial fluid in accordance with embodiments of the present invention may comprise all of the above elements except for water, creating an emulsion that requires water in order to be diluted for use, or the industrial fluid may be created as a final emulsion and used in an undiluted form. Suitable surfactants include, but are not limited to, C₁₆-C₁₈ fatty alcohol ethoxylates—with an ethoxylation range of 0-9 moles (fatty alcohol polyglycol ethers); C₁₆-C₁₈ fatty alcohol ethoxylate and propoxylate; C₆/C₈/C₁₆₋₁₈ alkyl polyoxyethylene ether carboxylic acids with a 2 to 9 mole ethoxylation range; alkyl ether ethoxylate mono phosphate esters—alkyl chain C₁₈, with a 2 to 5 mole ethoxylation range; ethoxylated oleine with a 6/9 mole ethoxylation range; and polyethylene glycol esters of C₁₆-C₁₈ fatty acids. Combinations of various surfactants, as mentioned above, may be particularly advantageous.

Suitable corrosion inhibitors include, but are not limited to amine/alkali salts of short chain carboxylic mono acids, di acids and tri acids, short chain acidic phosphate esters, including alkoxylated esters, semi-succinate half esters, amide-carboxylic acid salts, fatty amides, and amine and alkali sulphonates or their derivatives. Yellow metals include benzotriazole or its derivatives and tolutriazole or its derivatives. Suitable esters include, but are not limited to TMP (trimethylol propane) mono, di and tri esters of C₈-Cl₈ fatty acids, glycol esters of predominantly olely fatty acids, methyl or isopropyl esters of predominantly olely fatty acids or triglycerides, natural triglycerides , such as rapeseed, and modified natural oils such as blown rapeseed. Biocides (typically amine compounds) may also be included if desired. These include, but are not limited to, formaldehyde releasing agents including ortho-formal, hexahydratriazine and derivatives, methylene bis morpholene, oxazoladine and derivatives, isothiazolinones and derivatives and iodo propyl butyl carbamate-fungicide.

Other additives used in other lubricant systems, and other suitable examples of those materials listed above, will be apparent to those skilled in the art.

In the present invention it has been appreciated that the method and apparatus disclosed in US2013/0201785, available from Clariant AG under the name “NanoCon” when applied to the field of industrial fluids offers many advantages over traditional emulsification methods. This is particularly the case for water miscible fluids, such as those used in metalworking.

In order to test whether ensuring that substantially all the surfactant is bound within the structure of a micelle does indeed reduce the foaming of an industrial fluid, a sample of a commercially available sub-micron emulsion, NanoGel CCT (available from Clariant Produkte (Deutschland) GmbH) was examined. NanoGel CCT comprises caprylic/capri triglyceride, water, glycerine. Laureth-23, sodium dicocoylethlyenediamine PEG-15 sulfate, sodium lauroyl lactylate, behenyl alcohol, glyceryl stearate and glyceryl stearate citrate. The oleaginous components are comprised within micelles each having three surface layers of surfactant, accounting for substantially all of the surfactant within the emulsion. Sample 1 comprised 10 wt % NanoGel CCT and 90 wt % water, and Sample 2 comprised 5 wt % NanoGel CCT and 95% water. These were evaluated against a Control Sample 1 comprising 10 wt % Alusol 41 BF metalworking lubricant (available from Castrol Limited) and 90 wt % water.

Initial examination of Sample 1 and Sample 2 revealed that virtually no foaming was observed on mixing the NanoGel CCT with water. The samples then underwent several tests to determine their overall suitability for use in industrial fluids.

### Tapping Torque

A tapping torque test under ASTM 5619-00 (2011) was carried out to compare

Sample 1, Sample 2 and the Control Sample 1. This test determines the amount of torque required to form a thread in a pre-drilled hole in an aluminium alloy (A1ZnMgCu0.5). Results were as in Table 2, taking the performance of the Control Sample 1 as a performance index of 100:

TABLE 2
Tapping Torque Test

| Sample | Control Sample 1 | Sample 1 | Sample 2 |
|---|---|---|---|
| Performance Index | 100 | 93.5 | 99.4 |

As can be seen, the inclusion of 5 wt % of NanoGel CCT in water offers a small reduction in torque compared with the Control Sample. However, the inclusion of 10 wt% in water offers a significant reduction in torque compared with the Control Sample.

### Corrosion Inhibition

The ability of Sample 1 to inhibit corrosion was also investigated, following measurement of the pH of the emulsion of approximately pH 5 (slightly acidic). A standard corrosion inhibition test (immersion of cast iron chips in Sample 2 and then reviewed for staining on filter paper by the iron chips as in DIN 51360 (part 2)) was carried out. On immersion, the cast iron chips began to corrode, but after approximately 15 minutes the corrosion process slowed significantly, leading to a measure of corrosion inhibition. In order to determine whether this was a chemical (composition) or a physical (micelle) process within the NanoGel CCT, the constituent components of NanoGel CCT were mixed as Control Sample 2, and the test repeated. Interestingly the corrosion process continued as normal throughout the immersion of the cast iron chips, indicating that the micelle structure of the NanoGel CCT gave improved corrosion inhibition compared with not using a micelle physical structure within the emulsion.

The above examples involve the use of normal-phase micelles, that is, where the surfactant forms a surface layer where the hydrophilic heads of the surfactant molecules face outwards; forming an oil-in-water mixture (the oleaginous component is in emulsion in the aqueous component). However, it may be desirable to use an inverse-phase micelle structure, forming a water-in-oil mixture (the aqueous component is in emulsion in the oleaginous component).

One further advantage of using the micelle structure in an industrial fluid as outlined above is that a precise range of micelle sizes can be achieved. The distribution of the average diameters of the micelles follows a Gaussian profile, with a mean μ and a standard deviation σ. It is particularly advantageous for the standard deviation σ to be less than or equal to 0.2μ. For example, for a mean average micelle diameter of 0.3 μm, the standard deviation of the average micelle diameter is 0.06 μm or less. The average micelle diameter is an average of various diameter measurements take for a micelle, which in the case of spherical micelles is approximately equal to the micelle diameter (since there is little or no variation of the diameter regardless of where the measurement is taken). Preferably, the average micelle diameter is ≤0.3 μm. Suitable measurement techniques to determine both the average micelle diameter and the distribution of average micelle diameters include, but are not limited to, optical measurement techniques—for example, laser particle size analysis using a Beckman Coulter Laser Diffraction PS Analyzer (LS 13 320), and flow cytometry techniques. The advantage of having a narrow range of average micelle diameters lies in the ability of the industrial fluid to cover a surface fully. In a fluid where there is a wide range of average micelle diameters the coverage of the fluid across a surface is variable. This is due to regions of equal surface area having different volumes of fluid on them. However, if the average micelle diameter is in a small range the surface coverage is far more efficient and extensive, since regions of equal surface area will have approximately equal volumes of fluid on them. This leads to more even wear and improved surface/interface protection.

The viscosity index (VI) of various base oils stocks is given in Table 1 above. However, the kinematic viscosity of an oil base stock will also have an effect on whether or not the oil can be emulsified to create an aqueous emulsion. Typically oils suitable for use in the industrial fluids described above will have a kinematic viscosity of less than or equal to 20 cst at 40° C. However, oils may also be used having a higher kinematic viscosity than this, for example, up to 100cst at 40° C.

The use of micelles in oleaginous and aqueous emulsions to form lubricating industrial fluids finds use in many applications. For example, in addition to the metalworking fluids described above, such fluids may be used in an automotive application (including but not limited to engine or gearbox/drivetrain lubrication), an industrial process (including but not limited to gear lubrication, cutting applications, power generation and machinery lubrication) or a marine or subsea process (lubrication of drilling and cutting tools). Although the above examples illustrate a particular category of industrial fluids, other categories may also be based upon the emulsion/colloid system described above. Industrial fluids include lubricating, energy dissipating, energy generating, or energy transmission fluids and additives thereof. Energy dissipating fluids may include cooling fluids (such as drilling fluids used in subsea and terrestrial applications and industrial coolants), and energy generating fluids may include, but not be limited to fuels such as gasoline, diesel and kerosene. Energy transmission fluids include hydraulic and transformer fluids. Furthermore the industrial fluid may also find used as an additive to any of these fluids, in a similar manner to which additives are included in automotive lubricants and fuels. Such additives improve the performance, lifetime or operation of such fluids.

Various embodiments and other examples of industrial fluids will be apparent to the skilled person based upon the appended claims.

1. Industrial fluid comprising an emulsion of:
An oleaginous component;
An aqueous component; and
A surfactant;
wherein either the oleaginous component or the aqueous component forms micelles with the surfactant, and wherein the industrial fluid does not contain insoluble defoamers or anti-foam compounds to compensate for foaming.

2. Industrial fluid as claimed in claim 1, wherein substantially all of the surfactant is bound within micelles of the oleaginous or the aqueous component, such that there is substantially no unbound surfactant present in the fluid.

3. Industrial fluid as claimed in claim 1 or 2, wherein, in use, the industrial fluid is undiluted, diluted with a diluent or an additive for a carrier fluid.

4. Industrial fluid as claimed in claimed in claim 1, 2 or 3, wherein the average micelle diameter follows a Gaussian distribution having a mean μ, and wherein the standard deviation σ is less than or equal to 0.2μ.

5. Industrial fluid as claimed in any of claims 1 to 4, wherein the mean average diameter of the micelles is ≤0.3 μm.

6. Industrial fluid as claimed in any preceding claim, wherein the micelle is a normal-phase micelle, and the oleaginous component forms the centre of the micelle.

7. Industrial fluid as claimed in claim 6, wherein the surface comprises at least one surfactant monomer layer.

8. Industrial fluid as claimed in any preceding claim, wherein the structure of the surfactant dictates the structure of the micelle.

9. Industrial fluid as claimed in any of claims 1 to 6, wherein the micelle is an inverse-phase micelle, and at least some of the aqueous component forms the centre of the micelle.

10. Industrial fluid as claimed in any preceding claim, wherein the industrial fluid is chosen from: lubricating, energy dissipating, energy generating or energy transmission fluids or an additive thereto.

11. Industrial fluid as claimed in claim 10, wherein the industrial fluid is a lubricating fluid and wherein the oleaginous component comprises a lubricating composition.

12. Industrial fluid as claimed in claim 11, wherein the lubricating composition is a fully formulated lubricant.

13. Industrial fluid as claimed in claim 12, wherein the lubricating composition is a Group I, II, II, IV or V base oil.

14. Industrial fluid as claimed in claim 11, wherein the lubricating composition comprises a blend of components, at least one of which has lubricating properties.

15. Industrial fluid as claimed in claim 11, wherein the surfactant is an ionic surfactant, a non-ionic surfactant or a mixture thereof.

16. Industrial fluid as claimed in any of claims 1 to 10, wherein the industrial fluid is used in a destructive metalworking process.

17. Industrial fluid as claimed in any of claims 1 to 10, wherein the industrial fluid is used in a deformation metalworking process.

18. Industrial fluid as claimed any of claims 10 to 15, wherein the industrial fluid is used in an automotive application.

19. Industrial fluid as claimed in any of claims 1 to 10, wherein the industrial fluid is used in an industrial, marine or subsea process.

20. Industrial fluid as claimed in claim 10, wherein the industrial fluid is an energy dissipating fluid.

21. Industrial fluid as claimed in claim 10, wherein the industrial fluid is an energy generating fluid.

22. Industrial fluid as claimed in claim 21, wherein the industrial fluid is a fuel.

23. Industrial fluid as claimed in claim 10, wherein the industrial fluid is an energy transmission fluid.

24. Industrial fluid as claimed in claim 10, wherein the industrial fluid is an additive to lubricating, energy dissipating or energy generating fluids.

25. Industrial fluid as claimed in any preceding claim, wherein the industrial fluid does not contain defoamers or anti-foam compounds.

26. A method of forming an industrial fluid, comprising:
Forming a first fluid comprising a surfactant;
Forming a second fluid comprising an oleaginous compound;
Mixing the first fluid and the second fluid under a shear force to produce an intermediate fluid; and
Mixing an aqueous fluid and the intermediate fluid under laminar flow to create an industrial fluid.

27. Method of making an industrial fluid in accordance with any of claims 1 to 25 using the method as claimed in claim 26.

28. An industrial fluid made using the method of claim 26.
